(19) United States
(12) Patent Application Publication
(10) Pub. No.: US 2020/0398891 A1
(43) Pub. Date: Dec. 24, 2020

(54) ACTUATOR SYNCHRONIZATION IN A STEER-BY-WIRE STEERING SYSTEM

(71) Applicants: THYSSENKRUPP PRESTA AG, Eschen (LI); THYSSENKRUPP AG, Essen (DE)

(72) Inventors: Imre SZEPESSY, Mauren (LI); Gergely HORVÁTH, Fülöpszállás (HU)

(73) Assignees: ThyssenKrupp Presta AG, Eschen (LI); thyssenkrupp AG, Essen (DE)

(21) Appl. No.: 16/643,623

(22) PCT Filed: Sep. 15, 2017
(86) PCT No.: PCT/EP2017/073240

§ 371 Date: Mar. 2, 2020

(51) Int. Cl. B62D 6/00; B62D 5/00; B62D 5/04

(52) U.S. Cl. CPC B62D 6/008; B62D 5/0481; B62D 5/006

(57) ABSTRACT

A method can synchronize movement between a feedback actuator and a steering actuator in a steer-by-wire steering system of a motor vehicle. The steer-by-wire steering system may include a steering wheel, a feedback actuator connected to the steering wheel for providing road feedback to a driver, road wheels, and a steering actuator with an electric motor that operates in response to detected values of various steering parameters and orientates the road wheels in a desired direction. The method may involve detecting with an angle sensor a rotation of the electric motor's rotor caused by movement of the road wheels or the steering wheel. If movement is detected, a position change can be registered in a storage means. Upon ignition on, the feedback actuator or the steering actuator may be moved in accordance with the stored position change to maintain synchronization.

The present invention relates to a method for maintaining synchronization of a feedback actuator with a steering actuator in a steer-by-wire steering system of a motor vehicle according to the preamble of claim 1.

In a steer-by-wire steering system, the vehicle's steering wheel is disengaged from the steering mechanism. In such a steering system, there is no mechanical coupling between the steering wheel and the steering gear. Steering movement is achieved by a steering actuator with an electric motor. The steering actuator operates in response to detected values of various steering parameters, such as steering wheel angle and vehicle speed etc. The detected values are communicated electronically to the steering actuator from sensors, whereby the electric motor drives the rack and orients the steerable wheels in the desired direction.

Even though the mechanical linkage between the steering wheel and the road wheels has been eliminated, a steer-by-wire steering system is expected to produce the same functions and steering feel as a conventional mechanically linked steering system. The forces generated in moving the road wheels have to be fed back to the steering wheel to provide information for directional control to the driver. The feedback also contributes to a feeling of steering referred to as steering feel. In steer-by-wire steering systems the feedback and steering feel respectively is generated with a feedback actuator connected to the steering wheel. One necessity of a steer-by-wire steering system is a feedback actuator to steering actuator synchronization. The synchronization is problematic, if the road wheels are turned by hand e.g. to be able to repair suspension components or other parts in workshops. Furthermore the synchronization is problematic, if the steering wheel is turned by hand when the system is turned off (e.g. while getting into the car or out of the car). This moves the steering actuator and changes its position, which leads to an undesired offset in the steering system.

It is an object of the present invention to provide a method for maintaining synchronization of a feedback actuator with a steering actuator in a steer-by-wire steering system of a motor vehicle.

This object is achieved by a method having the features of claim 1.

Accordingly, a method for maintaining synchronization of a feedback actuator with a steering actuator in a steer-by-wire steering system of a motor vehicle, the steer-by-wire steering system having a steering wheel, a feedback actuator connected to the steering wheel for providing road feedback to a driver, a plurality of road wheels, and a steering actuator with an electric motor, which operates in response to detected values of various steering parameters and orientates the road wheels in a desired direction, wherein movement of the feedback actuator is synchronized with movement of the steering actuator, wherein said method comprises the steps of:
Detecting a rotation of the electric motor's rotor caused by movement of the road wheels and/or by movement of the steering wheel by at least one angle sensor;
If the movement is detected, the position change is registered in a storage means;
On ignition on, moving the feedback actuator or the steering actuator in accordance with the detected movement to maintain the synchronization of the feedback actuator with the steering actuator.

This way the synchronization is not lost, if the road wheels and/or the steering wheel are moved externally e.g. in the workshop. The at least one angle sensor can be the rotor position sensor or the steering angle sensor on the steering column.

To regain synchronization two options are possible:
The steering actuator will follow the position of the feedback actuator and they will be synced. The steer-by-wire system does not have to move the steering wheel, so the driver will not notice the synchronization. During the movement the steering actuator has limited actuator torque to ensure safe movement. If this scenario is not possible the system will try the second option. For example, if any obstacle prevents turning of the wheels the torque limit will be exceeded and the synchronization will be stopped.
During the second option the feedback actuator will follow the position of steering actuator in order to be synced. The vehicle will signal the driver about the situation and will move the steering wheel with limited torque. During the movement if the current of the feedback actuator rises over the limit, the steer-by-wire system will shut down the feedback actuator. In the next cycle the system will try it again.

Preferably, at least one angle sensor has a sleep-mode, which wakes-up the angle sensor periodically to detect and measure the rotation of the electric motor's rotor.

In another preferred embodiment the angle sensor wakes up upon a movement of either the rotor of the electric motor of the road wheel actuator or the rotor of the motor of the feedback actuator.

In a preferred embodiment the steering actuator is a rack actuator, which causes axial displacement of a steering rack for steering of the road wheels.

The steering actuator can as well be a road wheel actuator, which is arranged in proximity to a road wheel, wherein the road wheel is rotatably and operably connected to said steering actuator. In this case each road wheel has an assigned steering actuator. This way the steer-by-wire system is capable of steering the steerable road wheels independently of each other.

A preferred embodiment of the present invention will be described with reference to the drawing.

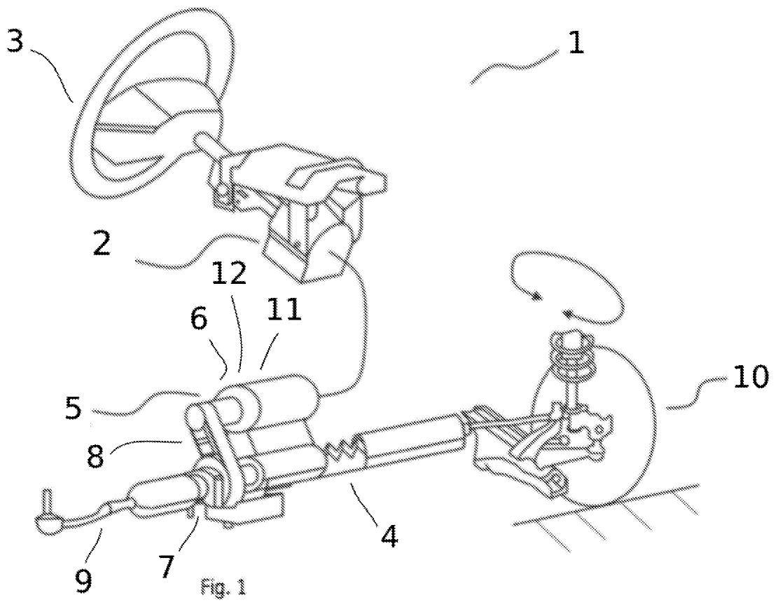

FIG. 1 shows a schematic illustration of a state of the art steer-by-wire steering system 1 of a motor vehicle. A feedback actuator 2 is connected to a steering wheel 3 in order to generate a steering feel. A rack 4 is driven by a steering actuator 5 having an electric motor 6 which is connected to a ball screw 7 arranged on the rack 4 via a belt drive 8. Rotation of the ball screw 7 leads to axial displacement of the rack 4. Steering rack rods 9 are connected to the rack 4 and to steered road wheels 10 of the motor vehicle. An electronic control unit (ECU) 11 controlling the electric motor 6 forms part of the steering actuator 5. The ECU can however be placed separately.

The steering actuator 5 further has a rotor angle sensor 12.

In order to maintain the synchronization between the feedback actuator and the steering actuator, e.g. if the road wheels are turned by hand or the steering wheel is moved externally, the movement is detected and on ignition on the feedback actuator or the steering actuator is moved in accordance with the detected movement. For that the steering actuator can be equipped with a sleep-mode rotor angle sensor, which is turned on periodically to detect and measure the rotation of the electric motor's rotor. The synchronization includes two options; First of all the steering actuator will follow the position of the feedback actuator and they will be synced. The steer-by-wire system does not have to move the steering wheel, so the driver will not notice the synchronization. During the movement the steering actuator has limited actuator torque to ensure safe movement. If this scenario is not possible the system will try the second option. For example, if any obstacle prevents turning of the wheels the torque limit will be exceeded and the synchronization will be stopped.

During the second option the feedback actuator will follow the position of steering actuator in order to be synced. The vehicle will signal the driver about the situation and will move the steering wheel with limited torque. During the movement if the current of the feedback actuator rises over the limit, the steer-by-wire system will shut down the feedback actuator. In the next cycle the system will try it again.

This method provides seamless maintaining of synchronization of the feedback actuator and the steering actuator and can be used after any repairs and/or reinitialization of steering actuator position.

The method is not limited to a steering actuator with ball screw mechanism or steering actuators arranged at a rack in general. In another embodiment the steer-by-wire steering system has steering actuators, which are arranged directly at the road wheels.

1.-9. (canceled)

10. A method for maintaining synchronization of a feedback actuator with a steering actuator in a steer-by-wire steering system of a motor vehicle, wherein the steer-by-wire steering system includes a steering wheel, a feedback actuator connected to the steering wheel for providing road feedback to a driver, road wheels, and a steering actuator with an electric motor that operates in response to detected values of various steering parameters and orientates the road wheels in a desired direction, wherein movement of the feedback actuator is synchronized with movement of the steering actuator, the method comprising:
detecting with an angle sensor a rotation of a rotor of the electric motor caused by at least one of movement of the road wheels or movement of the steering wheel;
registering a position change in a storage means if movement is detected; and
upon ignition on, moving the feedback actuator or the steering actuator in accordance with the position change that has been stored to maintain synchronization of the feedback actuator with the steering actuator.

11. The method of claim 10 comprising awakening the angle sensor from a sleep mode periodically to detect and measure rotation of the rotor.

12. The method of claim 10 wherein the steering actuator is a rack actuator that causes axial displacement of a steering rack for steering the road wheels.

13. The method of claim 10 wherein the steering actuator is a road wheel actuator that is disposed proximate to the road wheels, wherein at least one of the road wheels is rotatably and operably connected to the steering actuator.

14. The method of claim 10 wherein the steering actuator follows a position of the feedback actuator in order to be synced, with the steering wheel not moving, wherein during movement the steering actuator has limited actuator torque to ensure safe movement.

15. The method of claim 14 wherein if turning of the road wheels is prevented by an obstacle, the method comprises exceeding a torque limit and stopping synchronization.

16. The method of claim 10 wherein the feedback actuator follows a position of the steering actuator in order to be synced, the method comprising signaling a driver about movement of the steering wheel and the feedback actuator moving the steering wheel with limited torque.

17. The method of claim 16 wherein the steer-by-wire steering system shuts down the feedback actuator if a current of the feedback actutator exceeds a predefined limit.

18. The method of claim 17 wherein the steer-by-wire steering system retries synchronization.
